(19) United States
(12) Patent Application Publication
(10) Pub. No.: US 2006/0268108 A1
(43) Pub. Date: Nov. 30, 2006

(54) Video surveillance system, and method for controlling the same

(76) Inventor: Steffen Abraham, Hildesheim (DE)

Correspondence Address: STRIKER, STRIKER & STENBY, 103 EAST NECK ROAD, HUNTINGTON, NY, 11743, US

(21) Appl. No.: 11/410,743

(22) Filed: Apr. 25, 2006

(30) Foreign Application Priority Data
May 11, 2005 (DE) 102005021735.4

(51) Int. Cl. H04N 7/18

(52) U.S. Cl. 348/143; 348/159

(57) ABSTRACT

A video surveillance system has at least one camera for monitoring a surveillance zone, a storage for storing floor plan data of the surveillance zone, a display for displaying video images from the detection field of the camera, a unit for projecting the floor plan data into the video images, a unit for superimposing floor plan data with structures in the video images, and a unit for deriving camera parameters based on the superimposition of floor plan data with structures in the video image, and a control method for a video surveillance system is provided.

### BACKGROUND OF THE INVENTION

The invention relates to a video surveillance system. The invention also relates to a control method for a video surveillance system.

Video surveillance systems in which the surveillance zones are monitored with cameras that supply video images from their detection fields are known. In a video system of this kind, the detection field of each camera must be optimally oriented toward the surveillance zone to be monitored in order to assure that there are no gaps in the monitoring of the surveillance zone. In an extensive surveillance zone with a large number of cameras, this is a complex and expensive task.

A particularly advantageous version of the video surveillance system embodied according to the present invention has a graphic user interface. This user interface furnishes security personnel with floor plan data regarding the object to be monitored. It is also possible to display other camera images of the cameras provided for monitoring the surveillance zones.

The user interface enables the following displays. The detection field of the currently depicted camera is displayed in the floor plan of the object being monitored. This is particularly useful for panning and tilting cameras that can be pivoted manually or pivoted automatically by suitable actuators. In this context, the detection field of the camera can advantageously also be dynamically displayed in the floor plan. In addition, a guard can use a pointing device such as a mouse to mark an arbitrary position of the surveillance zone in the floor plan of the object to be monitored. The video surveillance system then automatically selects the camera whose detection field covers the surveillance zone marked with the pointing device and displays the corresponding camera image on the user interface (display).

If the camera in question is a panning and/or tilting camera, then the camera is automatically aimed at the corresponding position. In a variant, a display that can be split into at least two partial images can be provided in order to simultaneously display floor plan data of the surveillance zones on one side and video images of the surveillance zones on the other.

### SUMMARY OF THE INVENTION

Accordingly, it is an object of the present invention to provide a very flexible, inexpensive adjustment and calibration of a video surveillance system.

To accomplish this, the invention proposes a video surveillance system having at least one camera for monitoring a surveillance zone, storage means for storing floor plan data of the surveillance zone, means for displaying video images from the detection field of the camera, means for projecting the floor plan data into the video images, means for superimposing floor plan data with structures in the video images, and means for calibrating the camera.

A calibrated camera is a prerequisite in order for surveillance zones detected by the camera to be optimally displayed in a floor plan.

Advantageously, salient features such as edges and/or corners can be marked or activated in the display of the floor plan and then projected into the video images in order to be brought into alignment with corresponding structures and/or features therein.

The calibration data of the camera are derived in accordance with the present invention from this alignment process.

### BRIEF DESCRIPTION OF THE DRAWINGS

FIG. 1 shows of a video surveillance system with several cameras and several surveillance zones;

FIG. 2 is a building floor plan showing the camera placements and detection fields of the cameras;

FIG. 3 is a flowchart of the proposed calibration method;

FIG. 4 shows a user interface for an embodiment variant of the proposed calibration method;

FIG. 5 shows a user interface for another embodiment variant; and

FIG. 6 depicts a coordinate system of a floor plan, showing the rotation angle of a camera.

### DESCRIPTION OF THE PREFERRED EMBODIMENTS

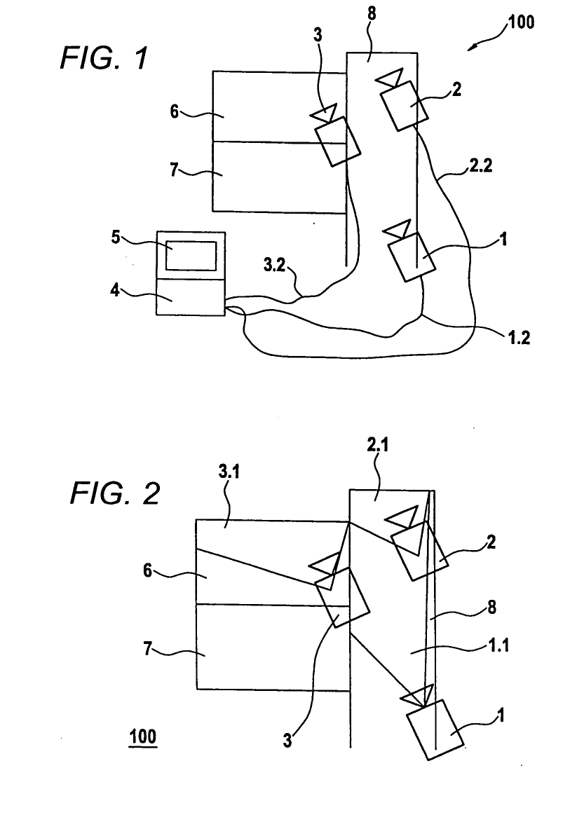

FIG. 1 is a schematic representation of a video surveillance system 100 equipped with several cameras 1, 2, 3 for video monitoring of surveillance zones 6, 7, 8. These surveillance zones can, for example, be subregions of a site to be guarded, such as an industrial plant, and in particular, can also be rooms inside a building to be monitored.

The cameras 1, 2, 3 are connected via lines 1.2, 2.2, 3.2 to a signal processing unit 4 that can be located in an equipment room away from the cameras 1, 2, 3. The lines 1.2, 2.2, 3.2 include transmission means for the output signals supplied by cameras, in particular video transmission means; control lines for the transmission of control signals between the signal processing unit 4; and lines for supplying power to the cameras 1, 2, 3. The part of the surveillance zone that the camera detects from its placement is referred to as the detection field of the camera. The detection fields of the cameras 1, 2, 3 should be dimensioned so that they are able to detect at least all of the entry points into the surveillance zones 6, 7, 8 with no gaps and also to detect the largest possible portions of the surveillance zones 6, 7, 8.

FIG. 2 shows an example of the projection of the schematically depicted cameras 1, 2, 3 onto a floor plan of the surveillance zones 6, 7, 8. It is clear from this depiction that the different-sized detection fields 1.1, 2.1, 3.1 of the cameras 1, 2, 3 detect the entry points into the individual surveillance zones 6, 7, 8 with no gaps and also cover the largest possible subregions of the surveillance zones 6, 7, 8. The detection fields of the cameras, which are depicted here merely in the form of a projection onto a plane, naturally cover a three-dimensional region of the surveillance zones.

The cameras are advantageously supported in mobile fashion and connected to actuators that can be remotely controlled by the signal processing unit 4 so that the camera detection ranges can be optimally aligned with the surveillance zones with which they are associated. Before now, once the cameras were installed in their surveillance zones, for example in a building, camera setup required a large amount of effort. In this context, the term camera setup includes inputting the camera placements and the detection fields of the cameras into a layout plan of the surveillance zones, for example a building floor plan. It is quite possible for a building floor plan of this kind to already be stored in digital form in a signal processing unit 4.

In order to display the camera placements, the position of the cameras within the surveillance zones must be known. Determining the detection fields of the cameras requires further knowledge regarding the aperture angle of the respective camera and its aiming direction in the respective room being monitored. Whereas the camera placements at least are already known, determining the aiming direction of the camera and the aperture angle of the camera during the setup phase can only be achieved with a relatively large amount of effort. This effort naturally increases along with the number of cameras to be set up.

In the description that follows, the position of the camera in its surveillance zone, its aperture angle, and the aiming direction of the camera, as well as the intrinsic calibration parameters of the camera such as image focal point and optical distortion are referred to all together by the generic term camera parameters. The camera parameters can be determined using photogrammetric methods. The use of these photogrammetric methods, however, requires that the associations between geometric features of the building floor plan and the video image be already known at the beginning of the setup phase. How this association comes about is irrelevant to the photogrammetric method.

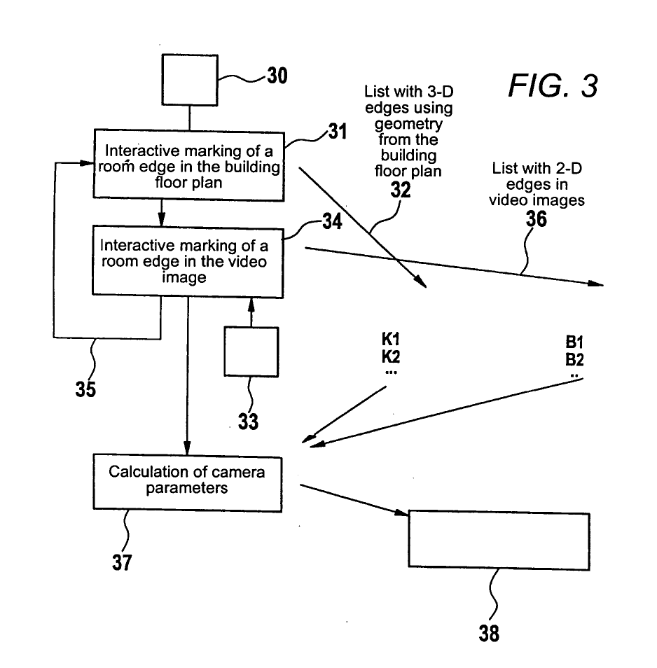

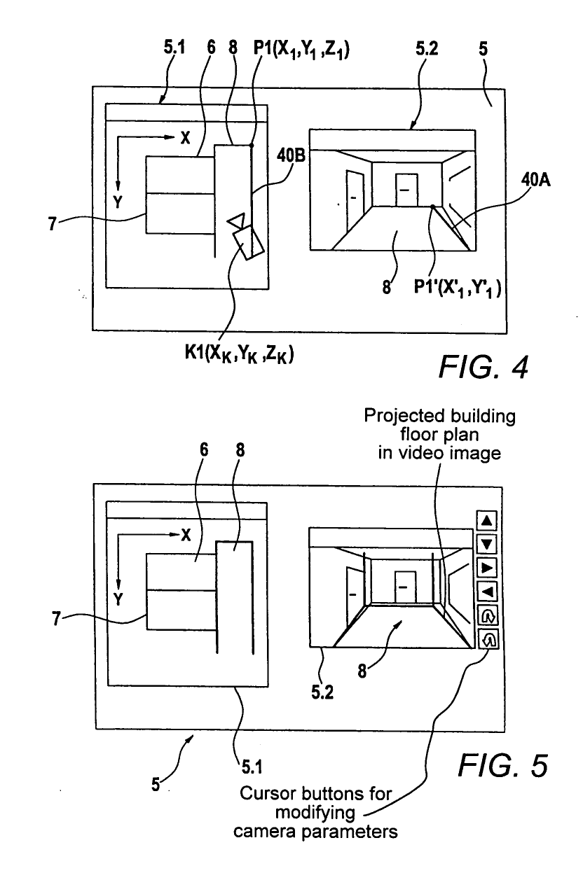

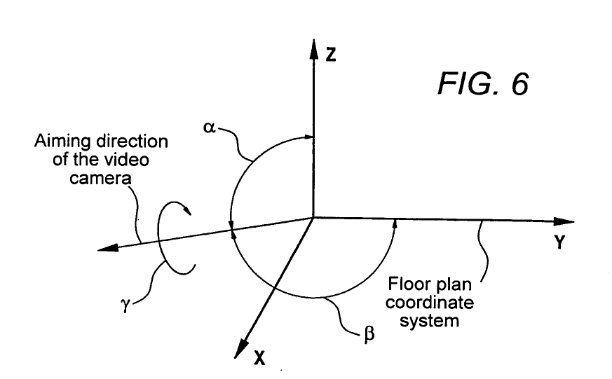

The present invention significantly facilitates this, as described below in conjunction with FIGS. 3 and 4. FIG. 3 is a flowchart of the calibration method according to the invention and FIG. 4 shows a user interface for a first embodiment variant of the method according to the invention. An example of the determination of the calibration parameters of a camera will be explained below. In the floor plan of an object to be monitored, namely a building, shown in the partial image 5.1 of FIG. 4, let us assume that a point, for example the corner of a room, has the spatial coordinates (x₁, y₁, z₁). The coordinates x₁ and y₁ indicate the position of this point in the xy plane and z₁ indicates the height of this point above the plane of a building floor.

The position of the camera K1 is indicated in this floor plan by the coordinates (xₖ, yₖ, zₖ). The orientation of the camera K1, i.e. its aiming direction in relation to this floor plan, is indicated by the angles α, β, γ (FIG. 5). These angles describe the rotation of the optical axes of the camera K1 in relation to the coordinate system (x, y, z) in the floor plan. The projection of a point (xᵢ, yᵢ, zᵢ) into the image coordinates of the video system shown in the partial image 5.2 in FIG. 4 can be described by the following equations:

$$\begin{matrix}{x}_{i}^{′} = c \frac{{r}_{11} ( {x}_{i} - {x}_{k} ) + {r}_{12} ( {y}_{i} - {y}_{k} ) + {r}_{13} ( {z}_{i} - {z}_{k} )}{{r}_{31} ( {x}_{i} - {x}_{k} ) + {r}_{32} ( {y}_{i} - {y}_{k} ) + {r}_{33} ( {z}_{i} - {z}_{k} )} + {x}_{H}^{′} & ( 1 ) \\ {y}_{i}^{′} = c \frac{{r}_{21} ( {x}_{i} - {x}_{k} ) + {r}_{22} ( {y}_{i} - {y}_{k} ) + {r}_{23} ( {z}_{i} - {z}_{k} )}{{r}_{31} ( {x}_{i} - {x}_{k} ) + {r}_{32} ( {y}_{i} - {y}_{k} ) + {r}_{33} ( {z}_{i} - {z}_{k} )} + {y}_{H}^{′} ; & ( 2 )\end{matrix}$$

The parameter c, the so-called camera constant, can be determined, for example, by means of the horizontal aperture angle Φ of the camera K1 and by means of the horizontal dimension of the video image dimx in pixels, in accordance with the following equation:

$$c = \frac{{dim}_{{x}^{′}}}{2 tan ( • / 2 )} \qquad ( 3 )$$

The image focal point with the parameters x′_{H} and y′_{H} in this example is suitably assumed to be situated in the middle of the video image, i.e. at the position (dim_{x′}/2, dimy′/2). The parameters rᵢⱼ in equations (1) and (2) are the elements of the rotation matrix R, which can be calculated from the angles α, β, γ.

$$\begin{matrix}R = ( \begin{matrix}{r}_{11} & {r}_{12} & {r}_{13} \\ {r}_{ 21} & {r}_{ 22} & {r}_{ 23} \\ {r}_{31} & {r}_{32} & {r}_{33}\end{matrix} ) \\ = ( \begin{matrix}1 & 0 & 0 \\ 0 & cos α & - sin α \\ 0 & sin α & cos α\end{matrix} ) ( \begin{matrix}cos β & 0 & sin β \\ 0 & 1 & 0 \\ - sin β & 0 & cos β\end{matrix} ) ( \begin{matrix}cos γ & - sin γ & 0 \\ sin γ & cos γ & 0 \\ 0 & 0 & 1\end{matrix} )\end{matrix} \qquad ( 4 )$$

where the parameters
K=(xₖ, yₖ, zₖ, α, β, γ)
are the calibration parameters of the camera K1 that are determined according to the invention.

As an example, the determination of the calibration parameters is described below in conjunction with the first exemplary embodiment. First, a technician setting up the video surveillance system uses a suitable pointing device such as a mouse to interactively mark the position, aiming direction, and aperture angle of a camera K1 in a floor plan of the object to be monitored. This yields the initial calibration parameters (Xₖ₀, Yₖ₀, Zₖ₀, α₀, β₀, γ₀, c₀). Then, the setup technician marks the edges of the outline in the floor plan and displays them as an overlay in the video image of camera K1. This yields associations between the coordinates of the floor plan, e.g. the room corners with the coordinates (x₁, y₁, z₁) and the associated image coordinates (x′_{M1}, y′_{M1}).

If the initial calibration parameters are used to project the coordinates of the floor plan (x₁, y₁, z₁) into the video image by means of the equations (1) and (2), then this yields the projected image coordinates (x′₁, y′₁). These do not generally coincide with the coordinates (x′_{M1}, y′_{M1}) due to the incorrect initial parameters. Then, a number of associations (N associations) of coordinates in the floor plan and interactively marked image coordinates are used to optimize the calibration parameters so as to minimize the discrepancy between the image coordinates (x′_{M1}, y′_{M1}) and the projection (x′₁, y′₁):

$${\sum }_{i =}^{N} {( {x}_{ M}^{ ′} - {x}_{ i}^{ ′} )}^{2} + {( {y}_{M}^{′} - {y}_{i}^{′} )}^{2} -> min \qquad ( 5 )$$

This optimization is advantageously executed using the least square root method by means of a linearization of the image equations (1), (2) in lieu of the initial calibration parameters (Xₖ₀, Yₖ₀, Zₖ₀, α₀, β₀, γ₀, c₀), in accordance with the following equation (6):

$$I = A Δ K , \\ with \\ I = ( \frac{\begin{matrix}{x}_{M - 1}^{′} - {x}_{1}^{′} ( {x}_{K 0} , {y}_{K 0} , {z}_{K 0} , {α}_{K 0} , {β}_{K 0} , {γ}_{0} , {c}_{0} , {x}_{1} , {y}_{1} , {z}_{1} ) \\ {y}_{M - 1}^{′} - {y}_{1}^{′} ( {x}_{K 0} , {y}_{K 0} , {z}_{K 0} , {α}_{K 0} , {β}_{K 0} , {γ}_{0} , {c}_{0} , {x}_{1} , {y}_{1} , {z}_{1} )\end{matrix}}{\begin{matrix}{x}_{MN}^{′} - {x}_{N}^{′} ( {x}_{K 0} , {y}_{K 0} , {z}_{K 0} , {α}_{K 0} , {β}_{K 0} , {γ}_{0} , {c}_{0} , {x}_{N} , {y}_{N} , {z}_{N} ) \\ {y}_{MN}^{′} - {y}_{N}^{′} ( {x}_{K 0} , {y}_{K 0} , {z}_{K 0} , {α}_{K 0} , {β}_{K 0} , {γ}_{0} , {c}_{0} , {x}_{N} , {y}_{N} , {z}_{N} )\end{matrix}} ) \\ A = ( \begin{matrix}\frac{\partial {x}_{1}^{′}}{\partial {x}_{K 0}} & 0 & \frac{\partial {x}_{1}^{′}}{\partial {c}_{0}} & 0 \\ \frac{\partial {y}_{1}^{′}}{\partial {x}_{K 0}} & 0 & \frac{\partial {y}_{1}^{′}}{\partial {c}_{0}} & 0 \\ \frac{\partial {x}_{N}^{′}}{\partial {x}_{K 0}} & 0 & \frac{\partial {x}_{N}^{′}}{\partial {c}_{0}} & 0 \\ \frac{\partial {y}_{N}^{′}}{\partial {c}_{K 0}} & 0 & \frac{\partial {y}_{N}^{′}}{\partial {c}_{0}} & 0\end{matrix} ) , and Δ K = ( \begin{matrix}\begin{matrix}Δ {x}_{K} \\ Δ {y}_{K} \\ Δ {z}_{K} \\ Δ α \\ Δβ \\ Δγ\end{matrix} \\ Δ c\end{matrix} ) \qquad ( 6 )$$

The solution
ΔK=(A^{T}A)⁻¹A^{t}I (7)
of this overdetermined linear equation system is used to determine corrections for the initial calibration parameters and, with the aid of these corrections, improved calibration parameters K1 are determined according to the following equation:
K₁=K₀+ΔK (8)

The linearization and calculation of corrections for the calibration parameters is advantageously carried out several times in iterative fashion until a convergence is achieved and the calibration parameters no longer change or only change very slightly.

In an exemplary embodiment in connection with the second embodiment variant, a setup technician once again uses a pointing device such as a mouse to interactively mark the position, the aiming direction, and the aperture angle of the camera K1 in the floor plan. This yields the initial calibration parameters (Xₖ₀, yₖ₀, zₖ₀, β₀, γ₀, c₀). The initial calibration parameters are used to project visible elements of the building floor plan, e.g. room corners, as an overlay into the video image of the camera K1. This is done by means of equations (1) and (2) with the aid of the initial calibration parameters. Then, the calibration parameters are interactively modified, for example by means of cursor buttons.

After each modification, the modified calibration parameters generate a new projection of the elements of the floor plan into the overlay of the video image. The setup technician continues the process until the projection of the floor plan elements lines up with the video image. The calibration parameters at the end of the process are the desired calibration parameters and are forwarded to subsequent process steps in the use of the video surveillance.

The user interface depicted in FIG. 4 is shown to the user on the display 5 of the signal processing unit 4. The user interface is split into two partial images 5.1 and 5.2. The partial image 5.2 on the right, i.e. to the right in the display 5 (FIG. 4), shows the user or guard the video image of the camera currently being worked on. The partial image 5.1 on the left, i.e. to the left in the display 5 (FIG. 4), shows the user an image of the floor plan of the surveillance zone 6, 7, 8 currently being worked on. This floor plan is suitably stored in a storage device and can be called up from it in order to be shown on the display 5. The user then uses the display and a suitable input device such as a mouse to interactively mark salient features in the floor plan of the surveillance zone shown in the left partial image of the display 5, e.g. room corners, floor edges, and the like, and activates them by means of this marking. Then, a pointing or input device such as a mouse is used to interactively draw the position of the salient features thus marked in the form of a marking line into the video image displayed in the right partial image 5.2. With knowledge of the coordinates of the marked salient features, it is possible to calculate the respective placement of the camera, the aiming direction of the camera, and other intrinsic parameters.

This sequence will be explained below in conjunction with the flowchart schematically depicted in FIG. 3. In a first step 30, floor plans of surveillance zones 6, 7, 8 stored in a storage device not shown in the drawing are read and displayed in a partial image 5.1 (FIG. 4) of the display 5. In the next step 31, a user uses the floor plan of the surveillance zones 6, 7, 8 shown in the partial image 5.1 of the display 5 to interactively mark salient features or objects such as a floor plan line 40B. Additional salient features such as floor plan lines of this kind or room corners are selected one after another. In this way, in step 32, a list of salient features is generated, whose coordinates are known from the floor plan. In a step 33, a camera 1, 2, 3 captures a video image of its detection field, which is displayed in the partial image 5.2 of the display 5. In step 34, the user once again marks salient features or objects in this video image, for example a line 40A adjoining the floor of the surveillance zone 8. Other salient features such as floor plan lines of this kind or room corners are selected one after another. In step 36, this process generates a list of these salient features from the video image. In step 37, camera parameters are determined based on the above-mentioned lists.

In an advantageous additional embodiment variant of the invention, a three-dimensional depiction of a surveillance zone derived from a floor plan is superimposed on a video image of the surveillance zone captured by a camera. This will be explained below in conjunction with FIG. 5. FIG. 5 also depicts a display 5 on which two partial images 5.1 and 5.2 are shown. The partial image 5.1 shows a floor plan of a surveillance zone 6, 7, 8. The user uses this partial image to mark the outlines of the surveillance zone 8. For example, the surveillance zone 8 is a room inside a building that is monitored by cameras. The partial image 5.2 shows a video image of this surveillance zone 8 captured by a camera. This video image displayed in the partial image 5.2 is then superimposed with an edge structure that corresponds to the edges of the surveillance zone 8 shown in the floor plan in partial image 5.1. To the right, next to the partial image 5.1, cursor buttons are provided that can be actuated by the user. These cursor buttons can be used to modify the parameters of the camera in question so that the video image can be brought into line with the edge structure superimposed on the video image. This makes it easy to determine the calibration parameters of the camera.

Cameras installed for a video surveillance system can be very easily and inexpensively calibrated by means of the invention since it requires no measurements at all to be carried out on the cameras themselves in order to determine their respective positions and aiming directions. This eliminates the cost for measuring means and the effort required for the measurement procedures. The interactive setup of the cameras enables the user to immediately plausibility test the achieved result. Only the setup of the cameras need be carried out by an appropriately qualified user. The installation of the cameras, however, can be carried out by less qualified auxiliary staff.

Simple dimensional data such as the height of the camera above the floor or the distance of the camera from a wall can be advantageously integrated into the calculating specifications for the camera parameters. These variables can also be simply determined by untrained installation personnel, for example by means of a laser or ultrasonic distance measurement device. The determination of the intrinsic parameters of the camera can also be assisted in a particularly advantageous way by capturing one or more images of a calibration body with a known geometry.

It will be understood that each of the elements described above, or two or more together, may also find a useful application in other types of constructions and methods differing from the types described above.

While the invention has been illustrated and described as embodied in a video surveillance system, and a method for controlling the same, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. A video surveillance system, comprising at least one camera for monitoring a surveillance zone; storage means for storing floor plan data of the surveillance zone; means for displaying video images from a detection field of said camera; means for projecting a floor plan data into the video images; means for superimposing the floor plan data with structures in the video images; and means for deriving calibration parameters of said camera based on the superimposition of the floor plan data with the structures in the video image.

2. A video surveillance system as defined in claim 1; and further comprising a display splittable into at least two partial images, with a first partial image for displaying the floor plan of the surveillance zone and a second partial image for displaying the video image that said camera captures in said detection field.

3. A video surveillance system as defined in claim 2; and further comprising input means for marking salient features in the first partial image.

4. A video surveillance system as defined in claim 2; and further comprising display means for displaying features marked in the first partial image in the second partial image.

5. A video surveillance system as defined in claim 2; and further comprising input means for shifting a feature, marked in the first partial image and displayed in the second partial image, in the second partial image.

6. A method of controlling a video surveillance system, comprising the steps of marking salient features on a floor plan of a surveillance zone; activating the features by the marking and displaying as marking elements in a video image in an alignment process that a camera captures with its detection field; bringing the marking elements into line with corresponding features in the video image; and deriving calibration parameters of the camera from said alignment process.

7. A method as defined in claim 6; and further comprising generating a three-dimensional model of a surveillance zone based on the floor plan of the surveillance zone; projecting the model into the video image that the camera captures of its detection field; and shifting features of the three-dimensional model so that they line up with corresponding features in the video image.

8. A method as defined in claim 6; and further comprising projecting a point from the floor plan of a surveillance zone into a point of a video image captured by the camera in accordance with following equations:
$${x}_{i}^{′} = c \frac{{r}_{11} ( {x}_{i} - {x}_{k} ) + {r}_{12} ( {y}_{i} - {y}_{k} ) + {r}_{13} ( {z}_{i} - {z}_{k} )}{{r}_{31} ( {x}_{i} - {x}_{k} ) + {r}_{32} ( {y}_{i} - {y}_{k} ) + {r}_{33} ( {z}_{i} - {z}_{k} )} + {x}_{H}^{′}$$
$${y}_{i}^{′} = c \frac{{r}_{21} ( {x}_{i} - {x}_{k} ) + {r}_{22} ( {y}_{i} - {y}_{k} ) + {r}_{23} ( {z}_{i} - {z}_{k} )}{{r}_{31} ( {x}_{i} - {x}_{k} ) + {r}_{32} ( {y}_{i} - {y}_{k} ) + {r}_{33} ( {z}_{i} - {z}_{k} )} + {y}_{H}^{′} , with$$
$$c = \frac{{dim}_{{x}^{′}}}{2 tan ( ϕ / 2 )} and$$
rᵢⱼ as elements of a rotation matrix
$$\begin{matrix}R = ( \begin{matrix}{r}_{11} & {r}_{12} & {r}_{13} \\ {r}_{ 21} & {r}_{ 22} & {r}_{ 23} \\ {r}_{31} & {r}_{32} & {r}_{33}\end{matrix} ) \\ = ( \begin{matrix}1 & 0 & 0 \\ 0 & cos α & - sin α \\ 0 & sin α & cos α\end{matrix} ) ( \begin{matrix}cos β & 0 & sin β \\ 0 & 1 & 0 \\ - sin β & 0 & cos β\end{matrix} ) ( \begin{matrix}cos γ & - sin γ & 0 \\ sin γ & cos γ & 0 \\ 0 & 0 & 1\end{matrix} ) ,\end{matrix}$$
where
Φ is an aperture angle of the camera (K1), K=(xₖ, yₖ, zₖ, α, β, γ, c) are calibration parameters of the camera (K1), and the angles (α, β, γ) represent a rotation of the camera (K1) in relation to a coordinate system (x, y, z).

9. A method as defined in claim 6; and further comprising determining optimized calibration parameters (K₁) in accordance with an equation K₁=K₀+ΔK, wherein K₀ represents initial parameters and ΔK is determined in accordance with an equation:
ΔK=(A^{T}A)⁻¹A^{T}I, with
$$I = ( \frac{\begin{matrix}{x}_{M 1}^{′} - {x}_{1}^{′} ( {x}_{K 0} , {y}_{K 0} , {z}_{K 0} , {α}_{K 0} , {β}_{K 0} , {γ}_{0} , {c}_{0} , {x}_{1} , {y}_{1} , {z}_{1} ) \\ {y}_{M 1}^{′} - {y}_{1}^{′} ( {x}_{K 0} , {y}_{K 0} , {z}_{K 0} , {α}_{K 0} , {β}_{K 0} , {γ}_{0} , {c}_{0} , {x}_{1} , {y}_{1} , {z}_{1} )\end{matrix}}{\begin{matrix}{x}_{MN}^{′} - {x}_{N}^{′} ( {x}_{K 0} , {y}_{K 0} , {z}_{K 0} , {α}_{K 0} , {β}_{K 0} , {γ}_{0} , {c}_{0} , {x}_{N} , {y}_{N} , {z}_{N} ) \\ {y}_{MN}^{′} - {y}_{N}^{′} ( {x}_{K 0} , {y}_{K 0} , {z}_{K 0} , {α}_{K 0} , {β}_{K 0} , {γ}_{0} , {c}_{0} , {x}_{N} , {y}_{N} , {z}_{N} )\end{matrix}} ) , \\ A = ( \begin{matrix}\frac{\partial {x}_{1}^{′}}{\partial {x}_{K 0}} & 0 & \frac{\partial {x}_{1}^{′}}{\partial {c}_{0}} & 0 \\ \frac{\partial {y}_{1}^{′}}{\partial {x}_{K 0}} & 0 & \frac{\partial {y}_{1}^{′}}{\partial {c}_{0}} & 0 \\ \frac{\partial {x}_{N}^{′}}{\partial {x}_{K 0}} & 0 & \frac{\partial {x}_{N}^{′}}{\partial {c}_{0}} & 0 \\ \frac{\partial {y}_{N}^{′}}{\partial {c}_{K 0}} & 0 & \frac{\partial {y}_{N}^{′}}{\partial {c}_{0}} & 0\end{matrix} ) , and Δ K = ( \begin{matrix}\begin{matrix}Δ {x}_{K} \\ Δ {y}_{K} \\ Δ {z}_{K} \\ Δ α \\ Δβ \\ Δγ\end{matrix} \\ Δ c\end{matrix} ) .$$
